(19) United States
(12) Patent Application Publication
(10) Pub. No.: US 2021/0317287 A1
(43) Pub. Date: Oct. 14, 2021

(54) RUBBER COMPOSITION

(71) Applicant: COMPAGNIE GENERALE DES ETABLISSEMENTS MICHELIN, Clermont-Ferrand (FR)

(72) Inventors: José-Carlos ARAUJO DA SILVA, Clermont-Ferrand Cedex 9 (FR); Frédéric LEMERLE, Clermont-Ferrand Cedex 9 (FR); Aurélie TRIGUEL, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 17/271,833

(22) PCT Filed: Sep. 11, 2019
(86) PCT No.: PCT/FR2019/052098

§ 371 Date: Feb. 26, 2021

(30) Foreign Application Priority Data
Sep. 11, 2018 (FR) FR1858136

(51) Int. Cl. C08K 13/02; B60C 1/00

(52) U.S. Cl. CPC C08K 13/02; B60C 1/0016

(57) ABSTRACT

A rubber composition which comprises at least 50 phr of a copolymer of ethylene and of a 1,3-diene which contains at least 50 mol % of ethylene units, a carbon black and a vulcanizing system comprising sulfur and a vulcanization accelerator which is a mixture of a primary accelerator and of a secondary accelerator is provided. The mass ratio between the amount of secondary accelerator and the total amount of accelerators is less than 0.7. Such a composition has a good compromise between the cohesion and curing properties.

The field of the present invention is that of rubber compositions based on highly saturated diene elastomer, which are intended to be used in a tyre, notably in its tread.

For the same elastomer, the level of stiffness of a rubber composition is defined by the degree of vulcanization of the elastomer, which depends both on the vulcanization kinetics and on the residence time of the rubber composition in the curing press. It is known that rubber compositions continue to cure, even once they have been removed from the curing presses. The continuation of curing outside the presses is all the greater when the rubber composition is in the form of a bulk object. If the stiffening of the rubber composition is not sufficient on leaving the press, the viscosity of the rubber composition then allows the formation of bubbles within the rubber composition when curing continues outside the press. Bubble formation within the rubber composition represents homogeneity defects in the rubber composition and can result in a decrease in the endurance of the tyre containing the rubber composition. It is thus desirable for the rubber composition, at the end of curing in the press, to have achieved a stiffness sufficient to prevent the formation of bubbles.

Highly saturated diene elastomers which contain at least 50 mol % of ethylene units have the drawback of vulcanizing according to kinetics that are slower than those of highly unsaturated diene elastomers which contain more than 50 mol % of diene units. Longer residence times in the curing presses are thus necessary to vulcanize rubber compositions containing highly saturated diene elastomers, especially if it is desired to avoid the bubble phenomena mentioned previously. The lower reactivity of highly saturated diene elastomers with respect to vulcanization is thus reflected by a longer time of occupation of the presses by the rubber composition and thus longer production cycles, which has the effect of reducing the productivity of tyre manufacturing plants.

Moreover, it is also important to provide rubber compositions which have good cohesion. For example, during rolling, a tread is subjected to mechanical stresses and stress factors resulting from direct contact with the ground. As a consequence, crack initiation sites are created. During their propagation at the surface or inside the tread, the crack initiation sites may lead to the rupture of the material which constitutes the tread. This tread damage reduces the service life of the tyre tread. Since the mechanical stresses and stress factors to which the tyre is subjected are amplified under the effect of the weight borne by the tyre, good cohesion is most particularly sought in the case of a tyre mounted on a vehicle carrying heavy loads.

There is still concern to provide rubber compositions with an improved compromise between the cohesion properties and the press curing times.

The Applicant has found a rubber composition which can meet this concern.

Thus, a first subject of the invention is a rubber composition based at least on a highly saturated diene elastomer, a carbon black and a vulcanizing system comprising sulfur and a vulcanization accelerator,
the highly saturated diene elastomer being a copolymer of ethylene and of a 1,3-diene containing ethylene units which represent at least 50 mol % of the monomer units of the copolymer,
the content of the highly saturated diene elastomer in the rubber composition being at least 50 phr,
the vulcanization accelerator being a mixture of a primary accelerator and of a secondary accelerator,
the mass ratio between the amount of secondary accelerator and the total amount of accelerators is less than 0.7, the total amount of accelerators being the sum of the mass amount of the primary accelerator and of the mass amount of the secondary accelerator in the rubber composition,
the mass ratio being calculated from the amounts expressed in phr.

Another subject of the invention is a tyre which comprises a rubber composition in accordance with the invention.

### I. DETAILED DESCRIPTION OF THE INVENTION

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b). The abbreviation “phr” means parts by weight per hundred parts of elastomer (rubber) (of the total of the elastomers if several elastomers are present).

In the present patent application, the mass ratios between the various constituents of the rubber composition are calculated from the contents or amounts of the constituents expressed in phr.

In the present description, the expression “composition based on” should be understood as meaning a composition including the mixture and/or the product of the in situ reaction of the various constituents used, some of these base constituents (for example the elastomer, the filler or the constituents of the vulcanizing system or other additive conventionally used in a rubber composition intended for the manufacture of a tyre) being liable or intended to react together, at least partly, during the various phases of manufacture of the composition intended for the manufacture of a tyre.

In the present patent application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

The compounds mentioned in the description may be of fossil or biobased origin. In the latter case, they may be partially or completely derived from biomass or may be obtained from renewable starting materials derived from biomass. Elastomers, plasticizers, fillers and the like are notably concerned.

The elastomer that is useful for the purposes of the invention is a highly saturated diene elastomer, which is preferably statistical, which comprises ethylene units resulting from the polymerization of ethylene. In a known manner, the term “ethylene unit” refers to the —(CH₂—CH₂)— unit resulting from the insertion of ethylene into the elastomer chain. The highly saturated diene elastomer is rich in ethylene units, since the ethylene units represent at least 50 mol % of all of the monomer units of the elastomer.

Preferably, the highly saturated diene elastomer comprises at least 65 mol % of ethylene units. In other words, the ethylene units preferentially represent at least 65 mol % of all of the monomer units of the highly saturated diene elastomer. More preferentially, the highly saturated diene elastomer comprises from 65 mol % to 90 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the term “1,3-diene unit” refers to units resulting from the insertion of the 1,3-diene via a 1,4 addition, a 1,2 addition or a 3,4 addition in the case of isoprene. The 1,3-diene units are those, for example, of a 1,3-diene containing 4 to 12 carbon atoms, such as 1,3-butadiene, isoprene, 1,3-pentadiene or an aryl-1,3-butadiene. Preferably, the 1,3-diene is 1,3-butadiene, in which case the highly saturated diene elastomer is a copolymer of ethylene and of 1,3-butadiene, which is preferably statistical.

The highly saturated diene elastomer that is useful for the purposes of the invention may be obtained according to various synthetic methods known to those skilled in the art, notably as a function of the targeted microstructure of the highly saturated diene elastomer. Generally, it may be prepared by copolymerization at least of a 1,3-diene, preferably 1,3-butadiene, and of ethylene and according to known synthetic methods, in particular in the presence of a catalytic system comprising a metallocene complex. Mention may be made in this respect of catalytic systems based on metallocene complexes, these catalytic systems being described in EP 1 092 731, WO 2004/035639, WO 2007/054223 and WO 2007/054224 in the name of the Applicant. The highly saturated diene elastomer, including the case when it is statistical, may also be prepared via a process using a catalytic system of preformed type such as those described in WO 2017/093654 A1, WO 2018/020122 A1 and WO 2018/020123 A1.

The highly saturated diene elastomer in the rubber composition as defined in any one of claims 1 to 14 preferably contains units of formula (I) or units of formula (II).

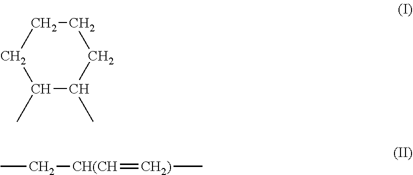

The presence of a saturated 6-membered ring unit, 1,2-cyclohexanediyl, of formula (I) in the copolymer may result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1), more preferentially the equation (eq. 2), o and p being calculated on the basis of all of the monomer units of the highly saturated diene elastomer.

0<o+p≤25 (eq. 1)

0<o+p<20 (eq. 2)

The highly saturated diene elastomer that is useful for the purposes of the invention may consist of a mixture of highly saturated diene elastomers which differ from each other in their microstructures or in their macrostructures.

According to the invention, the content of the highly saturated diene elastomer in the rubber composition is at least 50 parts by weight per hundred parts of elastomer (rubber) of the rubber composition (phr). Preferably, the content of the highly saturated diene elastomer in the rubber composition varies in a range extending from 80 to 100 phr. More preferentially, it varies in a range extending from 90 to 100 phr.

The vulcanizing system that is useful for the purposes of the invention has the essential characteristic of comprising sulfur and a vulcanization accelerator. By definition, the sulfur content and the content of vulcanization accelerator in the vulcanizing system are both strictly greater than 0 phr. Advantageously, the sulfur content in the rubber composition defined in any one of claims 1 to 15 is greater than 0.3 phr. Advantageously, the amount of vulcanization accelerator, i.e. the sum of the amount of primary accelerator and of the amount of secondary accelerator, in the rubber composition defined in any one of claims 1 to 15 is at least 0.5 phr.

The sulfur is typically provided in the form of molecular sulfur or of a sulfur-donating agent, preferably in molecular form. Sulfur in molecular form is also referred to by the term molecular sulfur. The term “sulfur donor” means any compound which releases sulfur atoms, optionally combined in the form of a polysulfide chain, which are capable of inserting into the polysulfide chains formed during the vulcanization and bridging the elastomer chains. The sulfur content in the rubber composition is preferentially less than 1 phr, preferably between 0.3 and 1 phr.

According to a more preferential embodiment of the invention, the sulfur content in the rubber composition is less than 0.95 phr, preferably between 0.3 phr and 0.95 phr.

According to an even more preferential embodiment of the invention, the sulfur content in the rubber composition is less than 0.8 phr, preferably between 0.3 phr and 0.8 phr.

The vulcanization accelerator is a mixture of a primary accelerator and of a secondary accelerator. The term “primary accelerator” denotes a single primary accelerator or a mixture of primary accelerators. Similarly, the term “secondary accelerator” denotes a single secondary accelerator or a mixture of secondary accelerators. The primary accelerator, whether or not it is in the form of a mixture, and the secondary accelerator, whether or not it is in the form of a mixture, thus constitute the only accelerators of the rubber composition. By definition, the contents of primary accelerator and of secondary accelerator in the vulcanizing system are both strictly greater than 0 phr.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators.

As examples of primary accelerators, mention may notably be made of sulfenamide compounds such as N-cyclohexyl-2-benzothiazylsulfenamide (“CBS”), N,N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide.

As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

Preferably, the vulcanization accelerator is a mixture of a sulfenamide and of a thiuram disulfide. The vulcanization accelerator is advantageously a mixture of N-cyclohexyl-2-benzothiazylsulfenamide and of a thiuram disulfide, more advantageously a mixture of N-cyclohexyl-2-benzothiazylsulfenamide and of tetrabenzylthiuram disulfide.

According to the invention, the mass ratio between the amount of secondary accelerator and the total amount of accelerators is less than 0.7, the total amount of accelerators being the sum of the mass amount of primary accelerator and the mass amount of secondary accelerator in the rubber composition. In other words, the mass content or mass amount of the secondary accelerator represents less than 70% by mass of the total amount of accelerators. Preferably, the mass ratio between the amount of secondary accelerator and the total amount of accelerators is greater than 0.05, more particularly between 0.05 and 0.7.

Preferably, the mass ratio between the amount of secondary accelerator and the total amount of accelerators is preferentially less than 0.5 and even more preferentially less than or equal to 0.3. These preferential ranges make it possible to even further optimize the compromise between the cohesion properties and the press curing times by very greatly reducing the pressing time while at the same time maintaining good limit properties, even in the presence of a crack initiation site in the rubber composition.

According to a preferential embodiment, the mass ratio between the sulfur content and the total amount of accelerators in the rubber composition is less than 1, preferably less than or equal to 0.7, more preferentially less than 0.6. The use of such ratios makes it possible to obtain compositions with further improved cohesion properties.

According to a particularly preferential embodiment of the invention, the sulfur content in the rubber composition is less than 1 phr and the mass ratio between the sulfur content and the total amount of accelerators in the rubber composition is less than 1. This twofold condition relating to the sulfur content and to the mass ratio between the sulfur content and the total amount of accelerators makes it possible to obtain compositions with even greater cohesion. The cohesion properties are all the more improved when the sulfur content and the mass ratio between the sulfur content and the total amount of accelerators are low and are notably in the preferential ranges mentioned in claims 7 and 8 for the sulfur content and claim 10 for the mass ratio between the sulfur content and the total amount of accelerators.

In a known manner, the vulcanizing system may also comprise vulcanization activators, for instance metal oxides such as zinc oxide or fatty acids such as stearic acid.

According to the invention, the rubber composition comprises a carbon black as reinforcing filler. A reinforcing filler typically consists of nanoparticles whose mean (mass-average) size is less than a micrometre, generally less than 500 nm, usually between 20 and 200 nm, in particular and more preferentially between 20 and 150 nm.

Any carbon black, notably the blacks conventionally used in tyres or their treads (known as tyre-grade blacks), is suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. When the rubber composition in accordance with the invention is used in a tread, the carbon black is preferentially a carbon black of the 100 or 200 series.

The content of carbon black may vary within a wide range and is adjusted by a person skilled in the art according to the envisaged use of the rubber composition, in particular in the tyre sector. For use of the rubber composition in a tread, in particular for vehicles intended to carry heavy loads, the content of carbon black in the rubber composition is preferentially between 25 phr and 65 phr. For such a use in the heavy goods vehicle sector, the rubber composition may have an insufficient level of reinforcement below 25 phr and may show excessive hysteresis above 65 phr.

The rubber composition that is useful for the purposes of the invention may also include all or some of the usual additives customarily used in elastomer compositions intended to be used in a tyre, for instance in a tyre tread. Such additives are, for example, fillers such as silicas, aluminas, processing agents, plasticizers, pigments, protective agents such as anti-ozone waxes, chemical anti-ozonants, and antioxidants.

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first phase (non-productive) is performed as a single thermomechanical step during which all the necessary constituents, the optional additional processing agents and the other various additives, with the exception of the sulfur and the vulcanization accelerators, are introduced into a suitable mixer such as a conventional internal mixer. The total kneading time in this non-productive phase is preferably between 1 and 15 minutes. After cooling the mixture thus obtained during the first non-productive phase, the sulfur and the vulcanization accelerator are then incorporated at low temperature, generally into an external mixer such as an open mill; the whole is then mixed (productive phase) for a few minutes, for example between 2 and 15 minutes.

The rubber composition may be calendered or extruded, preferably to form all or part of a tread profile of a tyre.

The tyre, which is another subject of the invention, which comprises a rubber composition in accordance with the invention, preferably comprises the rubber composition in its tread, in particular its tread, the portion of which intended to be in contact with the rolling ground consists totally or partly of a rubber composition in accordance with the invention. The tyre may be in raw form (i.e. before the step of curing the tyre) or in cured form (i.e. after the step of curing the tyre). The tyre is preferentially a tyre for a vehicle intended to carry heavy loads, for instance heavy goods vehicles and civil engineering vehicles.

The abovementioned characteristics of the present invention, and also others, will be understood more clearly on reading the following description of several implementation examples of the invention, which are given as non-limiting illustrations.

### II. EXAMPLES OF IMPLEMENTATION OF THE INVENTION

### II.1 Tests and Measurements:

### II.1-1 Determination of the Microstructure of the Elastomers:

The microstructure of the elastomers is determined by ¹H NMR analysis, combined with ¹³C NMR analysis when the resolution of the ¹H NMR spectra does not enable assignment and quantification of all the species. The measurements are performed using a Brüker 500 MHz NMR spectrometer at frequencies of 500.43 MHz for proton observation and 125.83 MHz for carbon observation.

For the insoluble elastomers which have the capacity of swelling in a solvent, a 4 mm z-grad HRMAS probe is used for proton and carbon observation in proton-decoupled mode. The spectra are acquired at rotational speeds of from 4000 Hz to 5000 Hz.

For the measurements on soluble elastomers, a liquid NMR probe is used for proton and carbon observation in proton-decoupled mode.

The preparation of the insoluble samples is performed in rotors filled with the analysed material and a deuterated solvent enabling swelling, generally deuterated chloroform (CDCl3). The solvent used must always be deuterated and its chemical nature may be adapted by a person skilled in the art. The amounts of material used are adjusted so as to obtain spectra of sufficient sensitivity and resolution.

The soluble samples are dissolved in a deuterated solvent (about 25 mg of elastomer in 1 mL), generally deuterated chloroform (CDCl3). The solvent or solvent blend used must always be deuterated and its chemical nature may be adapted by a person skilled in the art.

In both cases (soluble sample or swollen sample):

A 30° single pulse sequence is used for proton NMR. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The number of accumulations is set so as to obtain a signal-to-noise ratio that is sufficient for quantification of each unit. The recycle delay between each pulse is adapted to obtain a quantitative measurement.

The NMR measurements are performed at 25° C.

### II. 1-2 Mechanical Strength in the Presence of Crack Initiation Sites (Tearability):

The tearability strength and deformation are measured on a specimen drawn at 500 mm/minute to bring about rupture of the specimen. The tensile test specimen consists of a parallelepiped-shaped rubber slab, for example with a thickness of between 1 and 2 mm, a length of between 130 and 170 mm and a width of between 10 and 15 mm, the two side edges each being covered lengthwise with a cylindrical rubber bead (diameter 5 mm) for anchoring in the jaws of the tensile testing machine. Three very fine notches between 15 and 20 mm long are made using a razor blade, at mid-length and aligned in the lengthwise direction of the specimen, one at each end and one at the centre of the specimen, before starting the test. The force (N/mm) to be exerted to obtain rupture is determined and the elongation at break is measured. The test was performed in air, at a temperature of 100° C. High values reflect good cohesion of the rubber composition although having crack initiation sites.

### II.1-3 Tensile Tests:

The elongation at break (EB %) and breaking stress (BS) tests are based on the standard NF ISO 37 of December 2005 on an H2 dumbbell specimen and are measured at a traction speed of 500 mm/min. The elongation at break is expressed as a percentage of elongation. The breaking stress is expressed in MPa. All these tensile test measurements are performed at 60° C.

### II.1-4 Curing Properties:

The measurements are performed at 150° C. with an oscillating-chamber rheometer, according to the standard DIN 53529—Part 3 (June 1983). The change in the rheometric torque as a function of the time describes the change in the stiffening of the composition as a result of the vulcanization reaction. The measurements are processed according to the standard DIN 53529—Part 2 (March 1983). Ti is the induction period, i.e. the time necessary for the start of the vulcanization reaction. T95 is the time required to reach 95% conversion, i.e. 95% of the difference between the minimum and maximum torques. The conversion rate constant denoted as K (expressed in min⁻¹), of first order, calculated between 30% and 80% conversion, is also measured, which makes it possible to assess the vulcanization kinetics.

### II.2 Preparation of the Rubber Compositions:

The rubber compositions, the details of the formulation of which are given in Table 1, were prepared in the following manner:

The elastomer, the reinforcing filler and the various other ingredients, with the exception of the sulfur and the vulcanization accelerator, are successively introduced into an internal mixer (final degree of filling: about 70% by volume), the initial vessel temperature of which is about 80° C. Thermomechanical working (non-productive phase) is then performed in one step, which lasts in total approximately 3 to 4 min, until a maximum “dropping” temperature of 165° C. is reached. The mixture thus obtained is recovered and cooled, and sulfur and the vulcanization accelerator are then incorporated on a mixer (homofinisher) at 30° C., the whole being kneaded (productive phase) for an appropriate time (for example approximately ten minutes).

The compositions thus obtained are subsequently calendered, either in the form of slabs (thickness of 2 to 3 mm) or of thin sheets of rubber, for measurement of their physical or mechanical properties, or extruded in the form of a tyre tread.

The elastomer (EBR) is prepared according to the following procedure:

30 mg of metallocene [{Me₂SiFlu₂Nd(μ-BH₄)₂Li(THF)}₂, the symbol Flu representing the fluorenyl group of formula C₁₃H₈], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at room temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven.

The rubber compositions C5 to C11 are in accordance with the invention. The rubber compositions C12 and C13 are not in accordance with the invention, the ratio between the mass amount of secondary accelerator and the sum of the mass amount of primary accelerator and of the mass amount of secondary accelerator not being less than 0.7. Compositions C1 to C4 which do not contain any secondary accelerator are not in accordance with the invention.

### II.3 Results:

The results are given in Table 2.

The results show that the rubber compositions C5 to C11 are those which show the best compromise between the cohesion properties and the press curing time. Among these compositions in accordance with the invention, compositions C5 to C10 prove to be among the most advantageous both as regards the cohesion properties and as regards the press curing times. Composition C13, which is not in accordance, in which the secondary accelerator is the only accelerator in the rubber composition, makes it possible to reduce the press curing time, but this result is obtained at the expense of the cohesion properties. Composition C12, which is not in accordance, in which the secondary accelerator represents more than 70% by mass of the accelerator used, also makes it possible to reduce the press curing time, but this result is also obtained at the expense of the cohesion properties.

As regards compositions C1 to C4, which are not in accordance, they have good cohesion properties, but these results are obtained at the expense of the curing properties as regards the productivity, since the press curing times are much longer.

TABLE 1

| Composition | C1 | C2 | C3 | C4 | C5 | C6 | C7 | C8 | C9 | C10 | C11 | C12 | C13 |
|---|---|---|---|---|---|---|---|---|---|---|---|---|---|
| EBR (1) | 100 | 100 | 100 | 100 | 100 | 100 | 100 | 100 | 100 | 100 | 100 | 100 | 100 |
| Carbon black (2) | 40 | 40 | 40 | 40 | 40 | 40 | 40 | 40 | 40 | 40 | 40 | 40 | 40 |
| Antioxidant (3) | 2 | 2 | 2 | 2 | 2 | 2 | 2 | 2 | 2 | 2 | 2 | 2 | 2 |
| Anti-ozone wax | 1 | 1 | 1 | 1 | 1 | 1 | 1 | 1 | 1 | 1 | 1 | 1 | 1 |
| Stearic acid | 1.5 | 1.5 | 1.5 | 1.5 | 1.5 | 1.5 | 1.5 | 1.5 | 1.5 | 1.5 | 1.5 | 1.5 | 1.5 |
| ZnO | 2.5 | 2.5 | 2.5 | 2.5 | 2.5 | 2.5 | 2.5 | 2.5 | 2.5 | 2.5 | 2.5 | 2.5 | 2.5 |
| Accelerator 1 (4) | 1.2 | 0.8 | 1.1 | 1.43 | 1.13 | 1.07 | 1.01 | 0.95 | 0.96 | 0.96 | 0.66 | 0.36 | — |
| Accelerator 2 (5) | — | — | — | — | 0.13 | 0.19 | 0.25 | 0.31 | 0.10 | 0.15 | 0.6 | 0.9 | 1.26 |
| Total accelerators (6) | 1.2 | 0.8 | 1.1 | 1.43 | 1.26 | 1.26 | 1.26 | 1.26 | 1.06 | 1.11 | 1.26 | 1.26 | 1.26 |
| Ratio (7) | 0 | 0 | 0 | 0 | 0.1 | 0.15 | 0.2 | 0.25 | 0.09 | 0.14 | 0.48 | 0.71 | 1 |
| Sulfur | 0.5 | 1.5 | 1.1 | 0.94 | 0.56 | 0.56 | 0.56 | 0.56 | 0.70 | 0.45 | 0.56 | 0.56 | 0.56 |
| Sulfur/Accelerators | 0.4 | 1.8 | 1 | 0.66 | 0.44 | 0.44 | 0.44 | 0.44 | 0.66 | 0.41 | 0.44 | 0.44 | 0.44 |

(1) Elastomer containing 79 mol % of ethylene units, 7 mol % of 1,2-cyclohexanediyl units, 8 mol % of 1, 2 units of the butadiene part, and 6 mol % of 1, 4 units of the butadiene part
(2) N234
(3) N-(1,3-Dimethylbutyl)-N′-phenyl-p-phenylenediamine (Santoflex 6-PPD from the company Flexsys)
(4) N-Cyclohexyl-2-benzothiazolesulfenamide (Santocure CBS from the company Flexsys)
(5) Tetrabenzylthiuram disulfide (Perkacit TBZTD from the company Flexsys)
(6) Total amount of accelerators
(7) Mass ratio between the amount of accelerator 2 to the total amount of accelerator.

TABLE 2

| Composition | C1 | C2 | C3 | C4 | C5 | C6 | C7 | C8 | C9 | C10 | C11 | C12 | C13 |
|---|---|---|---|---|---|---|---|---|---|---|---|---|---|
| Curing properties (140° C.) | | | | | | | | | | | | | |
| Rate K (min⁻¹) | 0.08 | 0.07 | 0.05 | 0.09 | 0.11 | 0.11 | 0.11 | 0.12 | 0.09 | 0.09 | 0.11 | 0.09 | 0.07 |
| Ti (min) | 14 | 13 | 9 | 12 | 11 | 11 | 10 | 10 | 12 | 12 | 8 | 8 | 8 |
| T95 (min) | 50 | 55 | 65 | 47 | 40 | 38 | 36 | 35 | 44 | 44 | 36 | 41 | 49 |
| Properties in the cured state | | | | | | | | | | | | | |
| Traction at 60° C. | 756 | 421 | 449 | 527 | 641 | 608 | 565 | 563 | 557 | 671 | 441 | 367 | 318 |
| Elongation at break (%) | | | | | | | | | | | | | |
| Breaking stress (MPa) | 21 | 15 | 17 | 18 | 17 | 16 | 15 | 16 | 16 | 17 | 13 | 11 | 10 |
| Tearability at 100° C. | 316 | 58 | 70 | 98 | 206 | 159 | 126 | 95 | 116 | 306 | 67 | 48 | 50 |
| Elongation at break (%) | | | | | | | | | | | | | |
| Strength (N/mm) | 31 | 14 | 14 | 16 | 23 | 18 | 16 | 14 | 17 | 31 | 13 | 11 | 12 |

1. A rubber composition based at least on a highly saturated diene elastomer, a carbon black and a vulcanizing system comprising sulfur and a vulcanization accelerator,
the highly saturated diene elastomer being a copolymer of ethylene and of a 1,3-diene containing ethylene units which represent at least 50 mol % of the monomer units of the copolymer,
the content of the highly saturated diene elastomer in the rubber composition being at least 50 phr,
the vulcanization accelerator being a mixture of a primary accelerator and of a secondary accelerator,
the mass ratio between the amount of secondary accelerator and the total amount of accelerators is less than 0.7, the total amount of accelerators being the sum of the mass amount of the primary accelerator and of the mass amount of the secondary accelerator in the rubber composition,
the mass ratio being calculated from the amounts expressed in phr.

2. The rubber composition according to claim 1, in which the primary accelerator is a sulfenamide.

3. The rubber composition according to claim 1, in which the secondary accelerator is a thiuram disulfide.

4. The rubber composition according to claim 1, in which the mass ratio between the amount of secondary accelerator and the total amount of accelerators is greater than 0.05.

5. The rubber composition according to claim 1, in which the mass ratio between the amount of secondary accelerator and the total amount of accelerators is less than 0.5.

6. The rubber composition according to claim 1, in which the sulfur content is less than 1 phr.

7. The rubber composition according to claim 1, in which the sulfur content is less than 0.95 phr.

8. The rubber composition according to claim 1, in which the sulfur content is less than 0.8 phr.

9. The rubber composition according to claim 1, in which the mass ratio between the sulfur content and the total amount of accelerators is less than 1, the mass ratio being calculated from the contents and amount expressed in phr.

10. The rubber composition according to claim 1, in which the mass ratio between the sulfur content and the total amount of accelerators is less than or equal to 0.7 the mass ratio being calculated from the contents and amount expressed in phr.

11. The rubber composition according to claim 1, in which the 1,3-diene is 1,3-butadiene.

12. The rubber composition according to claim 1, in which the highly saturated diene elastomer comprises at least 65 mol % of ethylene units.

13. The rubber composition according to claim 1, in which the content of highly saturated diene elastomer in the rubber composition varies within a range extending from 80 to 100 phr.

14. The rubber composition according to claim 1, in which the carbon black content is between 25 phr and 65 phr.

15. A tire which comprises a rubber composition defined in claim 1.

16. The rubber composition according to claim 2, in which the primary accelerator is N-cyclohexyl-2-benzothiazylsulfenamide.

17. The rubber composition according to claim 3, in which the secondary accelerator is tetrabenzylthiuram disulfide.

18. The rubber composition according to claim 4, in which the mass ratio between the amount of secondary accelerator and the total amount of accelerators is between 0.05 and 0.7.

19. The rubber composition according to claim 5, in which the mass ratio between the amount of secondary accelerator and the total amount of accelerators is less than or equal to 0.3.

20. The rubber composition according to claim 6, in which the sulfur content is between 0.3 phr and 1 phr.
